(19) United States
(12) Patent Application Publication
(10) Pub. No.: US 2024/0122684 A1
(43) Pub. Date: Apr. 18, 2024

(54) DENTAL ABUTMENT GUIDE ROD AND METHOD

(71) Applicants: Liviu GOLDFELD, Nesher (IL); Tomer TSOHABANY, Nesher (IL)

(72) Inventor: Liviu GOLDFELD, Nesher (IL)

(21) Appl. No.: 18/379,329

(22) Filed: Oct. 12, 2023

Related U.S. Application Data
(60) Provisional application No. 63/379,293, filed on Oct. 13, 2022.

(51) Int. Cl. A61C 8/00

(52) U.S. Cl. CPC A61C 8/0074; A61C 2008/0084

(57) ABSTRACT

A guide rod and method for application are provided for facilitating abutment placement on dental implants. The guide rod is configured to fit through a mounting screw channel of an abutment, and has a mounting end. The mounting end is configured to fit a mounting socket of a dental implant onto which the abutment is to be mounted. The guide rod typically has a length that extends above the top of the abutment when the guide rod is mounted and the abutment is positioned on the dental implant. Once the abutment is positioned, the guide rod is replaced with a mounting screw.

### FIELD OF THE INVENTION

The present invention relates to dental implants and in particular to means for setting dental prostheses.

### BACKGROUND

Dental implants and abutments have been used for years to create dental prosthetics. As known in the art, a dental surgeon inserts an implant into an upper or lower jaw bone, and subsequently affixes an abutment onto the implant to support dental structures such as crowns, bridges, and dental arches.

Dental abutments, particularly multi-unit abutments, are often placed on implants to support dental structures such as multi-tooth protheses (e.g., bridges and dentures). Abutments may be angled, with common tilt angles including 18, 45, and 60 degrees. (Such abutments may be referred to as “angular” or “angulated head” abutments.

In actual dental practice, mounting of an angular abutment onto an implant may be a tedious and time-consuming task, frequently involving repetitive “searching” for correct orientation of the abutment on the implant. It is not uncommon for a surgeon to spend in excess of 30-60 minutes inserting an individual abutment. A system for orienting and installing abutments that could save time could also improve results.

### SUMMARY

Embodiments of the present invention provide equipment and methods including a guide rod for positioning a dental abutment on a dental implant. The guide rod is configured to fit through a mounting screw channel of an abutment, and has a mounting end, wherein the mounting end is configured to fit a mounting socket of a dental implant onto which the abutment is to be mounted.

In some embodiments, the guide rod has a length greater than the length of the mounting screw channel, such that the guide rod extends beyond a top of the abutment when the guide rod is mounted into the mounting socket of the dental implant and the abutment is positioned on the dental implant. The guide rod length may be sufficient for accessing the guide rod when the abutment is positioned on the dental implant, in order to remove the guide rod.

In further embodiments, the mounting end has threads matching threads of the mounting socket of the dental implant. The guide rod may have a knurled end, opposite the mounting end, for manually rotating the guide rod. Alternatively or additionally, the guide rode may have a removable handle, for placement at the end of the guide rod opposite the mounting end, for rotation of the guide rod.

Further provided is a method for abutment placement on dental implants with a guide rod that has a mounting end and where the guide rod is configured to fit through a mounting screw channel of an abutment. The mounting end is configured to fit a mounting socket of a dental implant onto which the abutment is to be mounted. The method may include positioning the abutment on the dental implant in a desired orientation while the guide rod is mounted in the mounting socket of the dental implant.

The method may further include applying the guide rod by 1) prior to positioning the abutment, passing the mounting screw channel of the abutment over the guide rod and mounting the guide rod in the mounting socket; and 2) after positioning the abutment, removing the guide rod from the mounting socket of the dental implant and from the mounting screw channel of the abutment, for subsequent insertion of a mounting screw.

In some embodiments passing the mounting screw channel over the guide rod is performed after screwing the guide rod into the mounting threads, and screwing the guide rod into the mounting threads is performed by attaching a removable handle to the guide rod, wherein the handle is subsequently removed in order to pass the mounting screw channel over the guide rod.

The abutment may be an angular abutment having an angled prosthetic screw socket and a positioning arm may be fixed in the angular prosthetic screw socket to assist in adjusting a position of the abutment on the dental implant while the axis of the mounting screw channel of the abutment is fixed by the guide rod to be coaxial with the mounting screw socket.

### BRIEF DESCRIPTION OF DRAWINGS

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice.

In the accompanying drawings:

FIGS. 1A-1B are schematic diagrams of prior art, indicating current practice for mounting of a dental abutment on an implant;

FIGS. 2A-2B are schematic diagrams of a guide rod for positioning a dental abutment on a dental implant, according to embodiments of the present invention;

FIGS. 3A-3E are schematic diagrams indicating stages of mounting of a dental abutment on a dental implant, facilitated by a guide rod, according to embodiments of the present invention;

FIGS. 4A-4B are schematic diagrams of a guide rod mounted on a dental implant for positioning a dental abutment on the dental implant, according to embodiments of the present invention;

FIGS. 5A-5B are schematic diagrams of a guide rod mounted on a dental implant, together with a positioning arm mounted in a prosthetic screw socket of a dental abutment, for positioning the dental abutment on the dental implant, according to embodiments of the present invention; and

FIG. 6 is a flow diagram of operating a guide rod for positioning a dental abutment on a dental implant, according to embodiments of the present invention.

### DETAILED DESCRIPTION

It is to be understood that the invention and its application are not limited to the system and methods described below or to the arrangement of the components set forth or illustrated in the drawings, but are applicable to embodiments that may be practiced or conducted in various ways.

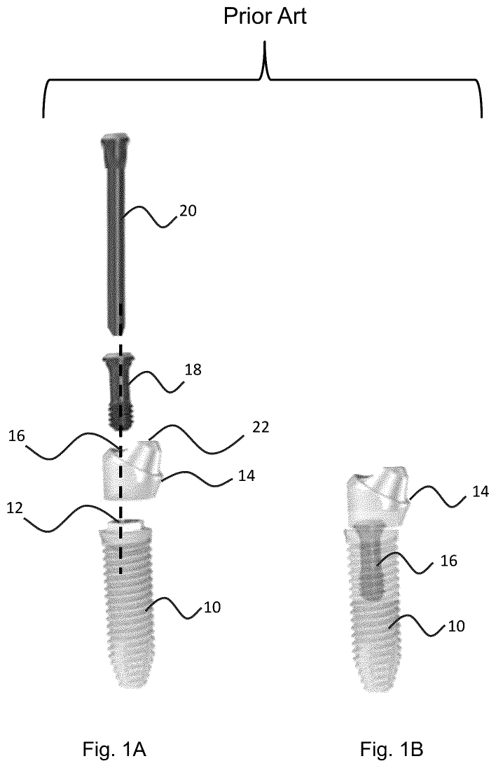

FIGS. 1A-1B are schematic diagrams of prior art practice in the field of dental implants. As shown in FIG. 1A, a dental implant 10, typically positioned in a jawbone, includes a mounting socket 12, for accepting an abutment 14. The figure indicates an angulated abutment, but there are many additional types of relevant abutments, including standard abutments, ball head abutments, and overdenture abutment. Abutments typically are relatively cylindrical and are manufactured in various heights, typically with a hexagonal base to fit the implant fixture. The abutment is typically secured in place on the implant with an abutment mounting screw 18 that passes through a channel or passage of the abutment, as described further hereinbelow, and is then secured in the mounting socket of the implant, as shown in FIG. 1B. Typically, a screwdriver 20 or similar tool is used to fasten the screw to the implant. The abutment shown, an angulated abutment, also has an angular socket 22 for prosthetic insertion. During mounting of the abutment, a positioning arm described further below may be inserted in the angular socket to assist with positioning.

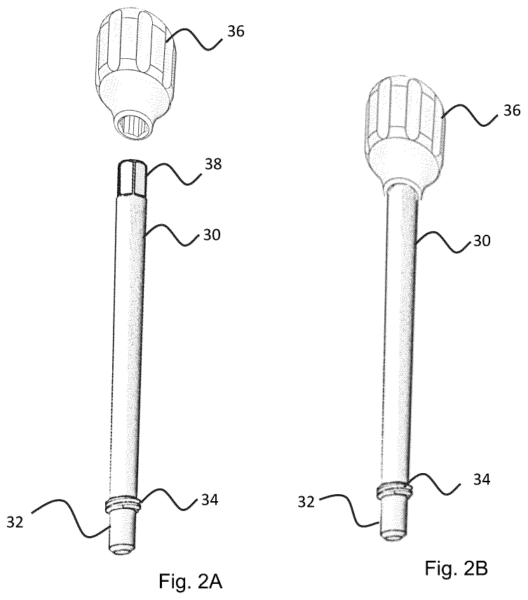

FIGS. 2A-2B are schematic diagrams of a guide rod 30 for positioning a dental abutment on a dental implant, according to embodiments of the present invention. The guide rod 30 typically has an elongated cylindrical shape, with a mounting end 32. The mounting end may also have screw threads 34, matching the threads of the target implant socket. As described below, the guide rod is affixed to an implant at its mounting end, in order to assist in positioning a dental abutment on the implant.

The guide rod may also have a cap or handle 36, which may be either permanently affixed or which may be removeable, as shown in FIG. 2A, so as to be attached at a handle end 38, as shown in FIG. 2B. The handle end may have a plug, such as a hex-shaped plug, to fit a socket of the handle 36. The handle may be configured, for example with ridges or a knurled pattern, to be conveniently grasped so as to rotate the guide post, in order to screw the guide post into and out of the implant.

In some examples, the length of the guide rod may be approximately 20-30 mm, with a diameter, depending on the implant, in a range of 1.5-2.0 mm. The length of the guide rod should be sufficient for the guide rod to extend above the height of the abutment when the guide rod is mounted and the placed through the abutment.

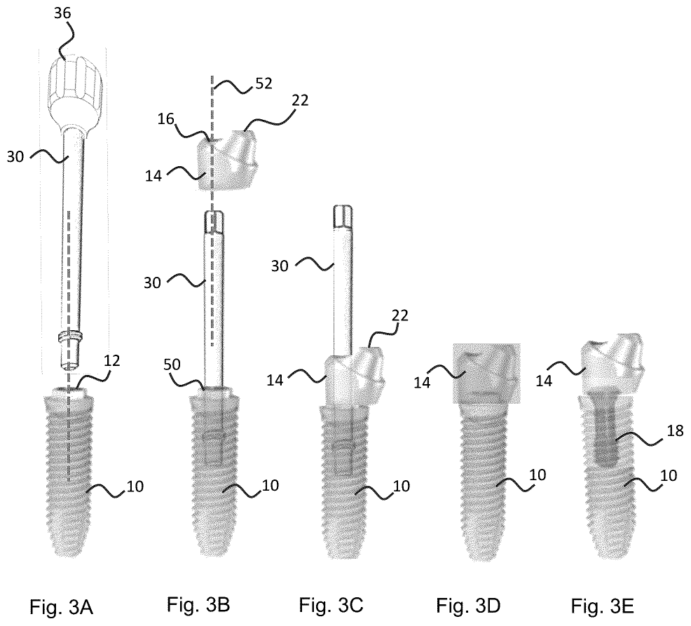

FIGS. 3A-3E are schematic diagrams indicating stages of positioning and

mounting of a dental abutment 14 on a dental implant 10, as facilitated by a guide rod 30, according to embodiments of the present invention. As indicated in FIG. 3A, a first step of positioning a dental abutment includes fixing the guide rod 30 to the mounting socket 12 of the implant 10, so as to be coaxially aligned with the mounting socket. The guide rod may be screwed into the mounting socket with the help of the handle 36. When the handle 36 is removeable, the abutment may be added after the guide rod is in place, by removing the handle (FIG. 3B). Alternatively, when the handle is not removeable, the abutment may be placed on the guide rod before the guide rod is inserted into the implant.

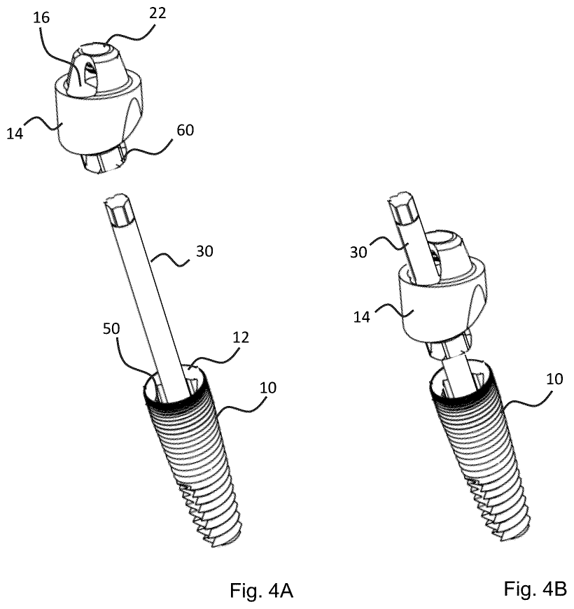

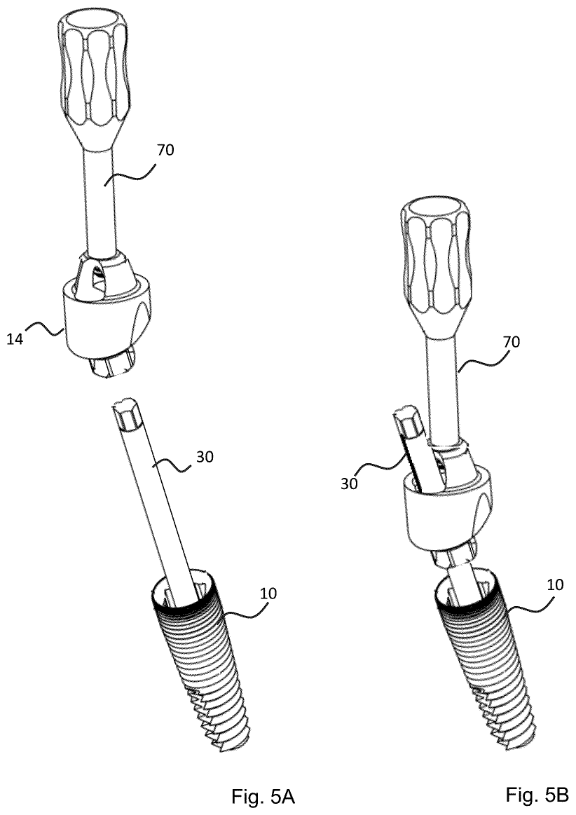

FIG. 3B shows the guide rod 30 affixed in the mounting socket, such that the mounting screw channel 16 of the abutment 14 may then be slid over the guide rod, to be subsequently positioned on the implant, as shown in FIG. 3C. The implant may have a protrusion 50 (e.g., hex-shaped) to match an opening at the bottom of the abutment. Alternatively, as indicated below with respect to FIGS. 4-5, the implant may have a shaped socket (e.g., hex-shaped) to match a protrusion at the bottom of the abutment, in addition to a narrower, co-centric, threaded socket.

The guide rod keeps the abutment oriented on a fixed axis 52, coaxially aligned with the implant mounting socket, so that the abutment may be rotated to a desired orientation. Fixing the axis of the abutment thereby facilitates rapid positioning of the abutment. Typically, the abutment is an angled abutment, as indicated, with an angled socket 22 for mounting of a dental prosthesis, such as a bridge or crown. During positioning of the abutment, a positioning arm known in the art may also be used to position the abutment in the desired position/orientation.

Once the abutment is positioned/oriented correctly, the guide rod may be unmounted from the implant, as shown in FIG. 3D. That is, the guide rod is unscrewed from the implant, and slid out of the mounting screw channel 16 of the abutment, without moving the abutment itself from its position on the implant. The abutment is held in place at this stage (for example, with the help of a positioning arm) and a mounting screw 18 is then inserted to mount the abutment, as shown in FIG. 3E (mounting the abutment to the implant as described above with respect to FIG. 1B).

FIGS. 4A-4B are schematic diagrams of a modified view of the guide rod 30 mounted on a dental implant 10, for positioning of a dental abutment 14, according to embodiments of the present invention. As is also described above, the guide rod is slid through a mounting screw channel 16 of the abutment, to fix the abutment on the axis of the mounting socket for easier positioning. The abutment is then mounted with a screw fixed in the implant 10. The implant may have a hex-shaped socket 50 co-centric with a threaded socket 12 into which the guide rod is screwed, as shown in FIG. 4A. The hex-shaped socket matching a hex protrusion 60 of the abutment. Positioning of the abutment with respect to the implant may include rotating the abutment to the optimal orientation on the hex socket 50.

FIGS. 5A-5B are schematic diagrams of a guide rod 30, mounted on a dental implant 10, as indicated above, with an additional tool, a positioning arm 70. The positioning arm is commonly put into the abutment screw socket 22 and used to hold the abutment while it is being mounted. Once the abutment is fixed on an axis that is coaxial with the mounting socket of the implant, the positioning arm is no longer free to move in any direction, but is also confined to circular motion around the axis, significantly improving the process of positioning the abutment correctly. The positioning arm may also be used to hold the abutment in place while the guide rod is removed and the mounting screw is inserted.

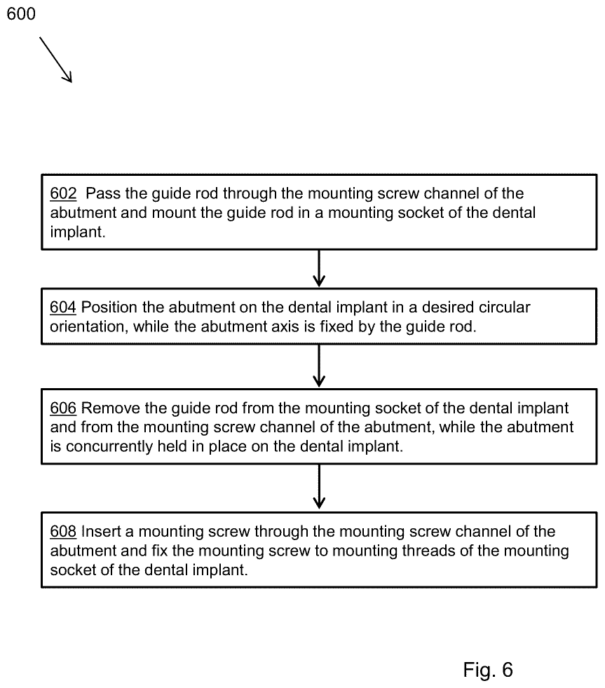

FIG. 6 is a flow diagram of a process 600 for operating a guide rod for positioning a dental abutment on a dental implant, according to embodiments of the present invention. The process includes the following steps.

At a step 602, pass the guide rod through the mounting screw channel of the abutment and mount the guide rod in a mounting socket of the dental implant. The abutment may be added after mounting the guide rod if a handle of the guide rod is removeable.

At a step 604, position the abutment on the dental implant in a desired circular orientation, while the abutment axis is fixed by the guide rod. Positioning may be assisted by a positioning arm, as described above, when the abutment is an angular abutment having an angled prosthetic screw socket.

At a step 606, remove the guide rod from the mounting socket of the dental implant and from the mounting screw channel of the abutment, while the abutment is concurrently held in place on the dental implant (i.e., in the orientation fixed at step 604).

At a step 608, insert a mounting screw through the mounting screw channel of the abutment and fix the mounting screw to mounting threads of the mounting socket of the dental implant. (The positioning arm, if used, may then be removed, as well.)

The following table provides a glossary for the reference numbers in the figures.

| | |
|---|---|
| 10 | Dental implant |
| 12 | Dental implant mounting socket |
| 14 | Dental abutment |
| 16 | Mounting screw channel of abutment |
| 18 | Abutment mounting screw |
| 20 | Abutment mounting screw screwdriver |
| 22 | Abutment screw socket for prosthetic |
| 30 | Abutment guide rod |
| 32 | Abutment guide rod mounting end |
| 34 | Abutment guide rod screw threads at mounting end |
| 36 | Abutment guide rod cap |
| 38 | Abutment guide rod handle end |
| 50 | Dental implant hex socket/mount |
| 52 | Vertical axis of abutment mounting |
| 60 | Abutment mounting plug |
| 70 | Positioning arm |
| 600 | Process for positioning abutment on implant |
| (602-608) | |

It is to be understood with respect to the above description that although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. Meanings of technical and scientific terms used herein are to be commonly understood as by one of ordinary skill in the art to which the invention belongs, unless otherwise defined. Method steps associated with the system and process can be rearranged and/or one or more such steps can be omitted to achieve the same, or similar, results to those described herein.

1. A guide rod for facilitating abutment placement on dental implants, wherein the guide rod is configured to fit through a mounting screw channel of an abutment, and has a mounting end, wherein the mounting end is configured to fit a mounting socket of a dental implant onto which the abutment is to be mounted.

2. The guide rod of claim 1, wherein the guide rod has a length greater than the length of the mounting screw channel, such that the guide rod extends beyond a top of the abutment when the guide rod is mounted into the mounting socket of the dental implant and the abutment is positioned on the dental implant.

3. The guide rod of claim 1, wherein the guide rod has a length sufficient for accessing the guide rod, in order to remove the guide rod, when the abutment is positioned on the dental implant.

4. The guide rod of claim 1, wherein the mounting end has threads matching threads of the mounting socket of the dental implant.

5. The guide rod of claim 1, further comprising a knurled end, opposite the mounting end.

6. The guide rod of claim 1, further comprising a removable handle, for placement at an end of the guide rod opposite the mounting end, for rotation of the guide rod.

7. A method for abutment placement on dental implants with a guide rod having a mounting end, wherein the guide rod is configured to fit through a mounting screw channel of an abutment, wherein the mounting end is configured to fit a mounting socket of a dental implant onto which the abutment is to be mounted, the method comprising positioning the abutment on the dental implant in a desired orientation while the guide rod is mounted in the mounting socket of the dental implant.

8. The method of claim 7, further comprising applying the guide rod by:
1) prior to positioning the abutment, passing the mounting screw channel of the abutment over the guide rod and mounting the guide rod in the mounting socket; and
2) after positioning the abutment, removing the guide rod from the mounting socket of the dental implant and from the mounting screw channel of the abutment, for subsequent insertion of a mounting screw.

9. The method of claim 8, wherein passing the mounting screw channel over the guide rod is performed after screwing the guide rod into the mounting threads, and wherein screwing the guide rod into the mounting threads is performed by attaching a removable handle to the guide rod, wherein the handle is subsequently removed in order to pass the mounting screw channel over the guide rod.

10. The method of claim 8, wherein the abutment is an angular abutment having an angled prosthetic screw socket and wherein the method further comprises mounting a positioning arm into the angular prosthetic screw socket and adjusting a position of the abutment on the dental implant with the positioning arm while the mounting screw channel is fixed by the guide rod on an axis coaxial with the mounting screw socket.
